(19) United States
(12) Patent Application Publication
(10) Pub. No.: US 2010/0011027 A1
(43) Pub. Date: Jan. 14, 2010

(54) POLICY RULE CONFLICT DETECTION AND MANAGEMENT

(75) Inventors: GREGORY W. COX, Schaumburg, IL (US); David L. RAYMER, JR., Watauga, TX (US); John C. STRASSNER, North Barrington, IL (US); Steven DAVY, Waterford (IE)

Correspondence Address: FLEIT, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 12/171,625

(22) Filed: Jul. 11, 2008

(51) Int. Cl. G06F 17/30

(52) U.S. Cl. 707/200; 707/E17.005

(57) ABSTRACT

A system, method, and information processing system manage policy rules. A first unique identifier (121) associated with a first policy rule (120) is compared to at least a second unique identifier (130) associated with a second policy rule (202) in a set of policy rules (128). The first policy rule (120) and each policy rule in the set of policy rules (128) are associated with at least one common characteristic. The set of policy rules (128) are updated to include the policy rule (120) in response to the first unique identifier (121) failing to substantially match the at least second unique identifier (130). A notification (422) indicating a potential policy rule conflict exits between the policy rule (120) and the set of policy rules (128) is generated in response to the first unique identifier (121) substantially matching the at least second unique identifier (130).

### FIELD OF THE INVENTION

The present invention generally relates to the field of network monitoring and management, and more particularly relates to managing and detecting policy rule conflicts.

### BACKGROUND OF THE INVENTION

In complex systems, many parties have interest in managing the system, and their differing interests are reflected in Strassner's Policy Continuum (See page 23 of Strassner, John. 2004. Policy-Based Network Management: Solutions for the Next Generation. Morgan Kaufmann Publishers, which is hereby incorporated by reference in its entirety). The involvement of multiple constituencies at multiple continuum levels introduces the possibility that policies can conflict. However, since policies are potentially complex combinations of events, conditions, and actions, their conflicts may not be easily detected and may be a function of the state of the managed system. In the face of such complexity, multiple means of conflict detection are warranted. Such complexity also introduces serious concern as to the level of resources needed to detect conflicts. Current policy management systems generally do not provide computationally efficient mechanisms for identifying policy conflicts.

Therefore a need exists to overcome the problems discussed above.

### SUMMARY OF THE INVENTION

In one embodiment, a method for managing policy rules is disclosed. The method includes comparing a first unique identifier associated with a first policy rule to at least a second unique identifier associated with a second policy rule in a set of policy rules. The first policy rule and each policy rule in the set of policy rules are associated with at least one common characteristic. The set of policy rules are updated to include the policy rule in response to the first unique identifier failing to substantially match the at least second unique identifier. A notification indicating a potential policy rule conflict exits between the policy rule and the set of policy rules is generated in response to the first unique identifier substantially matching the at least second unique identifier.

In another embodiment, an information processing system for managing policy rules is disclosed. The information processing system includes a memory and a processor communicatively coupled to the memory. A network manager is communicatively coupled to the memory and the processor. The network manager is adapted to compare a first unique identifier associated with a first policy rule to at least a second unique identifier associated with a second policy rule in a set of policy rules. The first policy rule and each policy rule in the set of policy rules are associated with at least one common characteristic. The set of policy rules are updated to include the policy rule in response to the first unique identifier failing to substantially match the at least second unique identifier. A notification indicating a potential policy rule conflict exits between the policy rule and the set of policy rules is generated in response to the first unique identifier substantially matching the at least second unique identifier.

In yet another embodiment, a system for managing policy rules is disclosed. The system includes at least one network and a plurality of managed entities communicatively coupled to the network. The system also includes an information processing system that is communicatively coupled to the plurality of managed entities. The information processing system includes a memory and a processor communicatively coupled to the memory. A network manager is communicatively coupled to the memory and the processor. The network manager is adapted to compare a first unique identifier associated with a first policy rule to at least a second unique identifier associated with a second policy rule in a set of policy rules. The first policy rule and each policy rule in the set of policy rules are associated with at least one common characteristic. The set of policy rules are updated to include the policy rule in response to the first unique identifier failing to substantially match the at least second unique identifier. A notification indicating a potential policy rule conflict exits between the policy rule and the set of policy rules is generated in response to the first unique identifier substantially matching the at least second unique identifier.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a general overview of an operating environment according to one embodiment of the present invention;

FIG. 2 is structure diagram of a process for identifying possible policy rule conflicts according to one embodiment of the present invention;

FIG. 3 is a directed acyclic graph that shows policy conflict detection with the order of tests optimized using overlap probabilities according to one embodiment of the present invention;

FIG. 4 is an operational flow diagram illustrating one process of identifying possible policy rule conflicts according to one embodiment of the present invention;

FIG. 5 is an operational flow diagram illustrating a process of identifying actual policy rule conflicts according to one embodiment of the present invention;

FIG. 6 is an operational flow diagram illustrating a process of creating policy rule groups according to one embodiment of the present invention; and

FIG. 7 is a block diagram illustrating a detailed view of an information processing system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

General Operating Environment

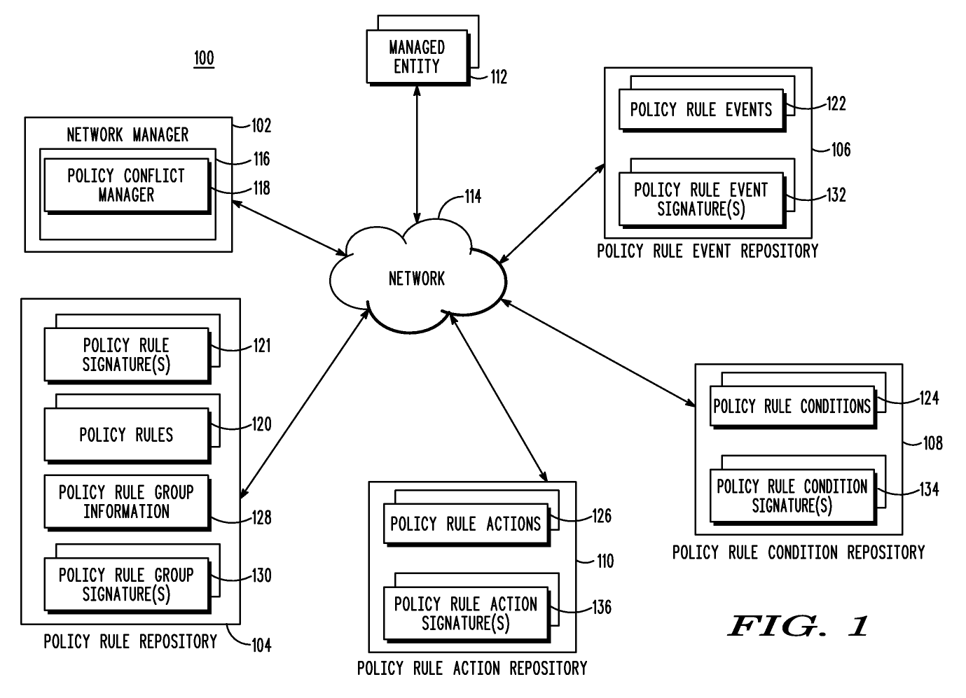

According to one embodiment of the present invention as shown in FIG. 1 a general view of an operating environment 100 is illustrated. In particular, the operating environment 100 includes one or more information processing systems 102 communicatively coupled to one or more policy rule repositories 104, policy rule event repositories 106, policy rule condition repositories 108, policy rule action repositories 110, and managed entities 112 via one or more networks 114. The one or more networks 114 include wired and/or wireless technologies. The repositories 104, 106, 108, 110 can be of a different physical entity or a different logical partition of an original physical entity. This enables both physical and logical security to be exercised on as a granular basis as possible.

The information processing system 102, in one embodiment, includes a network manager 116. The network manager 116 manages one or more managed entities 112 such as a client system, network hub, gateway, router, or the like using one or more policy rules 120 and their associated components. A policy rule component is defined as an object or set of objects that are part of a policy rule such as Policy Events 122, Policy Conditions 124, Policy Actions 126, and Metadata. A more detailed discussion on policy rules and their associated components can be found in Strassner, J., “Policy-Based Network Management”, Morgan Kaufman Publishers: 2003, ISBN 1-55860-859-1 and U.S. application Ser. No. 11/961,306, filed Dec. 20, 2007, entitled “Creating Policy Rules and Associated Policy Rule Components” (which is commonly owned herewith by Motorola, Inc.), both of which are hereby incorporated by reference in their entireties.

The policy conflict manager 118 efficiently detects policy conflicts by prioritizing the testing of the PolicyRules' Event, Condition, and Action components according to the probability that the events might be concurrent, the conditions might be satisfied, and the actions might be contradictory. The network manager 116 and the policy conflict manager 118 are discussed in greater detail below. It should be noted that the network manager 116 and the policy conflict manager 118 are not limited to residing within the information processing system 102.

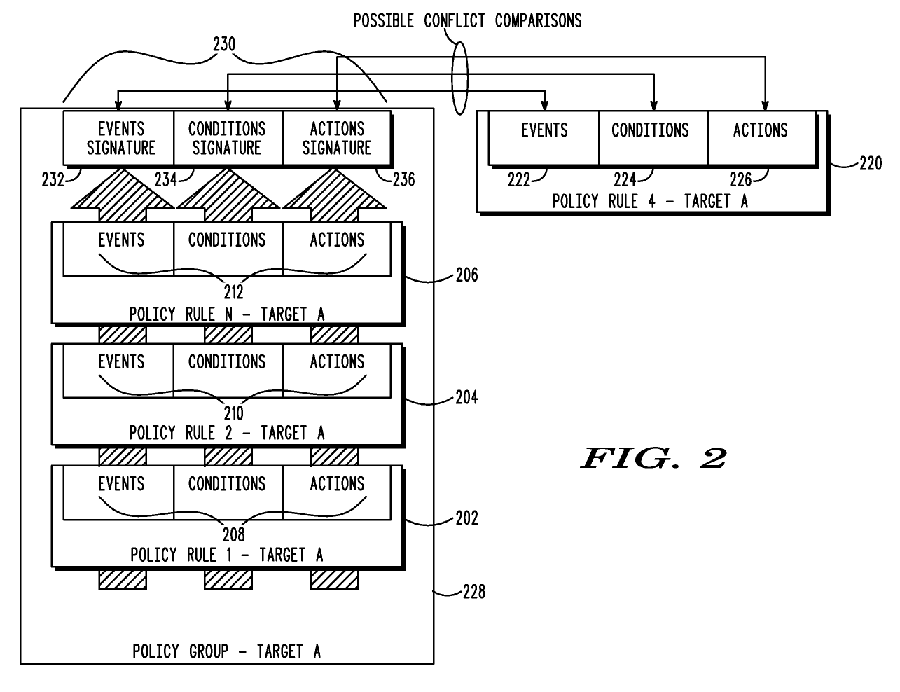

The policy rule repository 104, in one embodiment, includes a plurality of policy rules 120, policy rule group information 128 (policy rule groups), and one or more unique identifiers 130 for each policy rule group 128. The following is one non-limiting example of a unique identifiers/signatures. Assume the signature of a policy rule 120 is (E1, C1, A1) (where “E” designates an Event, “C” designates a Condition, and “A” designates an Action) to denote the set of events, conditions, and actions the rule includes. Now assume a policy rule group 128 including a given policy rule 202 (FIG. 2) having signature (E2, C2, A2) and policy rule 204 (FIG. 2) having signature (E3, C3, A3). A possible signature of policy rule group 128 is (250, 252).

It should be noted that without any loss of generality, the various embodiments of the present invention are applicable to either a set of policy rules directly (i.e., without any policy rule group information included), or a policy rule compared to one or more policy rule groups (including groups of policy rule groups). The use of policy groups is as only one example and does not limit the present invention in any way.

The use of the event repository 106, condition repository 108, and action repository 110 provide maximal reuse while keeping their management processes separate. However, one or more embodiments of the present invention also include a simpler case where a fewer number of repositories are used to store policy rules and their policy rule components. In the example of FIG. 1 each of these repositories 106, 108, 110 are communicatively coupled to the network manager 116 via the network 114, but can also be communicatively coupled to a messaging bus (not shown). It should be noted that one or more of these repositories 104, 106, 108, 110 can also reside within the information processing system 102.

The event repository 106 comprises Events 122 and a unique identifier 132 for each Event 122. The condition repository 108 comprises Conditions 124 and a unique identifier 134 for each Condition 124. The action repository 110 comprises Actions 126 and a unique identifier 136 for each Action 126. It should be noted that the policy rules 120 and policy rule components 122, 124, 126 can also be stored within a single repository as well. The policy rule group unique identifiers 130, event unique identifiers 132, condition unique identifiers 134, and action unique identifiers 136, in one embodiment, are a signature, hash function, and/or the like that uniquely identifies each of these elements.

Policy Rule Conflict Management

As discussed above, the network manager 116 via the policy conflict manager 118 efficiently detects policy conflict. In one embodiment, the policy conflict manager 118 detects policy conflicts by prioritizing the testing of the Event, Condition, and Action components of the policy rules 120 according to the probability that the events might be concurrent, the conditions might be satisfied, and the actions might be contradictory and/or overlap. The policy rule elements (Events, Conditions, or Actions) least likely to confirm conflict are tested first according to one or more embodiments of the present invention. If the first tested element shows that conflict is not possible (e.g. the Conditions cannot be simultaneously satisfied or the Events do not overlap), then the detection can exit indicating no conflict, saving computational loading, which is a significant concern in complex policy-managed systems.

The policy conflict manager 118, in one embodiment, optimizes conflict detection according to the following definition of policy conflict: A policy conflict occurs when the events and conditions of two or more policy rules that apply to the same set of managed objects overlap in time (e.g., occur wholly or in part concurrent with each other) and are simultaneously satisfied, respectively, but the actions of two or more of these policy rules conflict with each other (e.g., perform contradictory actions to the same managed object). (See page 162 of Strassner, John. 2004. Policy-Based Network Management: Solutions for the Next Generation. Morgan Kaufmann Publishers). Note that policies that apply to different Policy Targets cannot conflict, according to the above definition.

Computational efficiency is a significant concern in policy-based systems. Large numbers of possibly conflicting policy rules are likely to reside within a managed system. The network manager 118, in one embodiment, groups policy rules 120 with substantially identical policy targets (i.e. that “apply to the same set of managed objects”) and creates unique identifiers 130 such as “signatures” that reflect the Events, Conditions, and Actions of the policy rules within the group 128. Unique identifiers 131 can also be applied to single Policy Rules. Note that, as with command signatures of programming languages, policy rule and policy rule component signatures provide an efficient way of summarizing the functionality of the policy rule or policy rule component.

The policy conflict manager 118 can test new policy rules 120 against the policy group 128 with the same policy target as the new policy rule 120, comparing the Events, Conditions, and Actions of the new rule 120 against each of the corresponding policy Events, Conditions, and Actions of each policy rule in the policy rule group that is being tested. Alternatively, the same computation can be done more efficiently by comparing the signature of the policy rule 120 with the signature of each of the policy rules in the policy rule group 128, identified by its unique signature 130. The unique identifiers 130 and comparisons are generated and performed such that the possibility of policy conflict can be authoritatively eliminated or confirmed. If the conflict manager 118 determines that a conflict is possible (e.g. determine that a probability of a conflict is above a given threshold) after this comparison, then the policy conflict manager 118 further performs pair-wise comparisons of each of the policy rule components of the new policy rule 120 to each of the policy rule components of each policy rule of the policy group 128.

The pair-wise comparisons allow the conflict manager 118 to identify if an actual policy conflict exists or does not exist. Since these latter comparisons are potentially time-consuming and computationally assuming, one embodiment first checks the signature of a new policy rule to the signatures of a set of policy rules that may or may not be a part of one or more policy rule groups; all potential conflicts are then rechecked by performing a pair-wise comparison of the Events, Conditions, and Actions of the new policy rule against the Events, Conditions, and Actions of each of the policy rules that have the potential to conflict with the new policy rule. Actual conflicts are then reported. It should be noted that false positives from the initial group-level comparison are possible.

For example, FIG. 2 shows a procedural structure for determining whether a potential conflict exists between a policy group 228 and a new policy rule 220. In particular, FIG. 2 shows a policy group 228 comprising a plurality of policy rules 202, 204, 206. Each of these policy rules 202, 204, 206 have a common policy target, which in the example of FIG. 2 is “Target A”. However, it should be noted that the present invention is not limited to grouping policy rules by a common target. For example, policy rules can also be grouped by other characteristics such as common events, common conditions, semantic similarity, and the like. In addition, it is assumed that the phrase “policy target” can mean one or more policy targets, each of which is a managed object.

Each policy rule 202, 204, 206 in the policy group is associated with a set of policy components 208, 210, 212. In one embodiment, the set of policy components are Events, Conditions, and Actions. The network manager 116 creates a unique identifier 230 associated with the policy group 228. This unique identifier 230 is comprised of a unique identifier 232 associated with the Events of the group 228, a unique identifier 234 associated with the conditions of the group 228, and a unique identifier 236 associated with the actions of the group 228. It should be noted that a single unique identifier that includes a combination of these signatures is not required, since one implementation is to determine which set of Events, Conditions, and/or Actions can possibly be in conflict with the Events, Conditions, and/or Actions of the new policy rule 220. Hence, one embodiment assigns and uses the Events, Conditions, and Actions unique identifiers 232, 234, 236 to perform a pair-wise comparison against the Events, Conditions, and Actions 222, 224, and 226 of the policy rule 220.

The aggregation of policy components together to form a unique identifier such as a signature allows for a quick assessment of the possibility of conflict between a new policy rule 220 and policy rules 202, 204, 206 in the policy group 228. The aggregation, in one embodiment, is designed to allow false positives while preventing false negatives. False positives merely incur the added computational burden of pair-wise comparison of the new policy rule to members of the group to determine whether policy conflict actually exists according to the present invention. A false negative in the group comparison can lead to completely overlooking actual policy conflict and subsequent system malfunction as a consequence.

When the network manager 116 detects a new policy rule 220, the conflict manager 118 determines if the new policy rule 220 is associated with a characteristic that is common to the policy group 228. For example, the policy conflict manager 118 determines if the new policy rule 220 is associated with a target, event(s), condition(s), or action(s) that is common to the policy group 228. This can be efficiently determined by comparing the signatures 121 of either the policy rule 220 to each of the policy rules in the policy group 228, or to ensure a more detailed check, to compare the signatures of the Events, Conditions, and Actions of the policy rule 220 to the signatures of the Events, Conditions, and Actions for each policy rule in the policy group 228.

For example, pattern recognition can be used to determine if the Events 222, 232 of the new policy rule 220 and the policy group 228 overlap (e.g., occur during all or part of the same time period), whether the Conditions 224, 234 of the new policy rule 220 and the policy group 228 are satisfied at substantially the same time, and whether the Actions 226, 236 of the new policy rule 220 and the policy group 228 contradict (i.e., perform conflicting actions) and/or overlap (e.g., perform substantially the same action as) each other. If a possible conflict is identified by the conflict manager 118, the conflict manager 118 uses a pair-wise operation to compare the new policy rule 220 to each policy rule 202, 204, 206 in the policy group 228.

For example, the conflict manager 118 compares the Events, Conditions, and Actions of the new policy rule 220 to the Events, Conditions, and Actions of each policy rule 202, 204, 206 in the policy group 228. A conflict exists when at least two policy rules have the following pre-conditions that result in a policy conflict: (1) concurrently triggered Events (i.e., events that “overlap” in time); (2) mutually satisfied Conditions (i.e., conditions that “overlap”); and (3) execution of Actions that attempt to move the managed system into substantially different states. When the conflict manager 118 determines that a conflict exists, the conflict manager 118 removes the policy rule(s) from the policy group 228 that conflicts with the new policy rule 220 and notifies a user of the conflict, or removes the new policy rule 220, depending on the needs of the application and other considerations, such as the safety and/or time required to uninstall the policy rules of the policy group 228. Alternatively, the conflict manager 118 can perform automated conflict resolution operations to resolve the conflict. Once the conflict has been removed from the policy group 228, the conflict manger 118 updates the unique identifier(s) 232, 234, 236 associated with the policy group 228 to reflect that the conflict has been removed.

As stated above, the conflict manager 118 efficiently detects policy conflict by prioritizing the testing policy rule components such as Event, Condition, and Action components according to the probability that the events might be concurrent, the conditions might be satisfied, and the actions might be contradictory. Stated differently, the policy rule elements (Events, Conditions or Actions) least likely to confirm conflict are tested first. If the first tested element shows that conflict is not possible (e.g. the Conditions cannot be simultaneously satisfied), then the detection can exit indicating no conflict, saving computational loading, which is a significant concern in complex policy-managed systems.

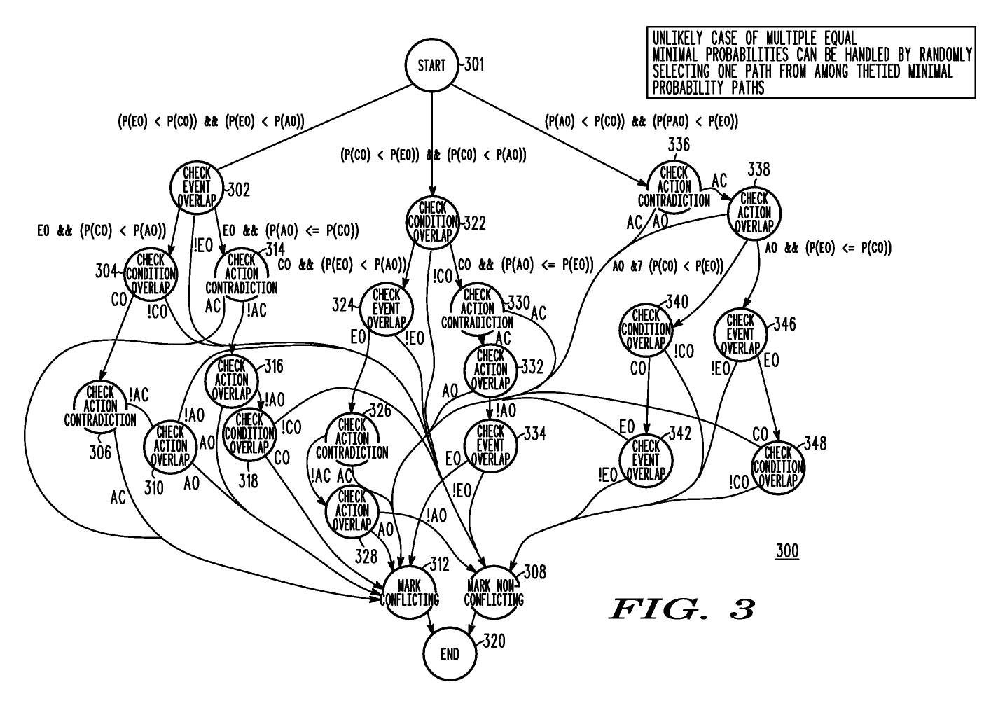

FIG. 3 is a directed acyclic graph 300 that shows policy conflict detection with the order of tests (“checks” in the graph) optimized using overlap probabilities according to the various embodiments of the present invention. The nodes of the graph are functions to be executed by the conflict manager 118. The edges of the graph are labeled with conditions (e.g., EO && (P(CO)<P(AO))) for taking that transition to the next function. Unlabeled transitions are unconditional. The graph 300 allows merging of edges bound for the same destination function for the sake of compactness. The shorthand used for the edge/transition conditions is as follows:

EO—events overlap

P(EO)—probability that events overlap

CO—conditions overlap

P(CO)—probability that conditions overlap

AC—actions contradict

P(AO)—probability that actions overlap

Note that a “!” symbol preceding any of the above denotes the negative of that meaning. For example, !EO means that there is no event overlap, while EO means that there is an event overlap.

FIG. 3 shows that in one embodiment, if the probability of an event overlap is less than the probability of a condition overlap and the probability an event overlap is less than the probability of an action overlap then a check function event overlap is performed at node 302. If the event overlap and the probability of condition overlap is less than the probability of action overlap then a check condition overlap function is performed at node 304. From node 304 if the conditions do not overlap then the new policy rule 120 is marked as non-conflicting at node 308 and the process ends at node 320. If the conditions overlap then a check action contradiction function is performed at node 306. If the actions contradict then the new policy rule 120 is marked as conflicting at node 312 and the process ends at node 320. If the actions do not contradict then a check action overlap function is performed at node 310. If the actions do not overlap then the new policy rule 120 is marked as non-conflicting at node 308 and the process ends at node 320. However, if the actions do overlap then the new policy rule 120 is marked as conflicting at node 312 and the process ends at node 320.

Returning to node 302, if the events do not overlap then the new policy rule 120 is marked as non-conflicting at node 308 and the process ends at node 320. If the event overlap and the probability of action overlap is less than or equal to the probability of condition overlap then a check action contradiction function is performed at node 314. If the actions contradict then the new policy rule 120 is marked as conflicting at node 312 and the process ends at node 320. If the actions do not contradict then a check action overlap function is performed at node 316. If the actions do not overlap then the new policy rule 120 is marked as non-conflicting at node 308 and the process ends at node 320. If the actions do overlap then a check condition overlap function is performed at node 318. If the conditions do not overlap then the new policy rule 120 is marked as non-conflicting at node 308 and the process ends at node 320. If the conditions do overlap then the new policy rule 120 is marked as conflicting at node 312 and the process ends at node 320.

Returning to the Enter node 301, if the probability of condition overlap is less than the probability of event overlap and the probability of condition overlap is less than the probability of action overlap then a check condition overlap function is performed at node 322. If conditions overlap and the probability of event overlap is less than the probability of action overlap then a check event overlap function is performed at node 324. If the events do not overlap then the new policy rule 120 is marked as non-conflicting at node 308 and the process ends at node 320. If the events do overlap then an action contradiction function is performed at node 326.

If the actions do contradict then the new policy rule 120 is marked as conflicting at node 312 and the process ends at node 320. If the actions contradict then the new policy rule 120 is marked as conflicting at node 312 and the process ends at node 320. If the actions do not contradict then a check action overlap function is performed at node 328. If the actions do not overlap then the new policy rule 120 is marked as non-conflicting at node 308 and the process ends at node 320. If the actions do overlap then the new policy rule 120 is marked as conflicting at node 312 and the process ends at node 320. Returning to node 322, if the conditions do not overlap then the new policy rule 120 is marked as non-conflicting at node 308 and the process ends at node 320.

With respect to node 322, if the conditions overlap and the probability of the action overlap is less than or equal to the probability of event overlap a check action contradiction function is performed at node 330. If the actions contradict then the new policy rule 120 is marked as conflicting at node 312 and the process ends at node 320. If the actions do not contradict then a check action overlap function is performed at node 332. If the actions overlap then the new policy rule 120 is marked as conflicting at node 312 and the process ends at node 320. If the actions do not overlap then a check event overlap function is performed at node 334. If the events overlap then the new policy rule 120 is marked as conflicting at node 312 and the process ends at node 312. If the events do not overlap then the new policy rule 120 is marked as non-conflicting at node 308 and the process ends at node 320.

Returning to the Enter node 301, if the probability of action overlap is less than the probability of condition overlap and the probability of action overlap is less than the probability of event overlap then a check action contradiction function is performed at node 336. If the actions contradict then the new policy rule 120 is marked as conflicting at node 312 and the process ends at node 320. If the actions do not contradict then a check action overlap function is performed at node 338. If the actions overlap then the new policy rule 120 is marked as conflicting at node 312 and the process ends at node 320. If the actions do not overlap and the probability of condition overlap is less than the probability of event overlap then a check condition overlap function is performed at node 340. If the conditions do not overlap then the new policy rule 120 is marked as non-conflicting at node 308 and the process ends at node 320. If the conditions overlap then a check event overlap function is performed at node 342. If the events do not overlap then the new policy rule 120 is marked as non-conflicting at node 308 and the process ends at node 320. If the events do overlap then the new policy rule 120 is marked as conflicting at node 312 and the process ends at node 320.

Returning to node 338 if the probability of event overlap is less than or equal to the probability of condition overlap then a check event overlap function is performed at node 346. If the events do not overlap then the new policy rule 120 is marked as non-conflicting at node 308 and the process ends at node 320. If the events do overlap then a check condition overlap function is performed at node 348. If the conditions do not overlap then the new policy rule 120 is marked as non-conflicting at node 308 and the process ends at node 320. If the conditions do overlap then the new policy rule 120 is marked as conflicting at node 312 and the process ends at node 320.

It should be noted that action overlap is a necessary but not sufficient condition for actions being contradictory and thus leading to policy conflict. For example, identical actions would be overlapping, but taking the same action twice is not considered to be contradictory and does not lead to policy conflict. Also, the “check” functions in the graph 300 can be computationally intensive since the events, conditions, and actions being tested can be complex (e.g. grouped events, compound conditions). However, in general, performing the same function twice can be considered at best inefficient and at worst disruptive. For example, there is also the possibility that an action could itself be computationally complex (e.g., resetting a device). Such drastic actions should, in general, be done as a last resort and a minimum number of times. Hence, one embodiment detects such inefficiencies and enables the administrator to decide if they are to be eliminated or not.

As can be seen the conflict manager efficiently detects policy conflicts. The testing of the policy rule Event, Condition, and Action components are prioritized according to the probability that the events might be concurrent, the conditions might be satisfied, and the actions might be contradictory. The policy rule elements (Events, Conditions, or Actions) least likely to confirm conflict are tested first. If the first tested element shows that conflict is not possible (e.g. the Conditions cannot be simultaneously satisfied), then the detection can exit indicating no conflict, saving computational processing, which is a significant concern in complex policy-managed systems.

Process of Identifying Potential Policy Rule Conflicts

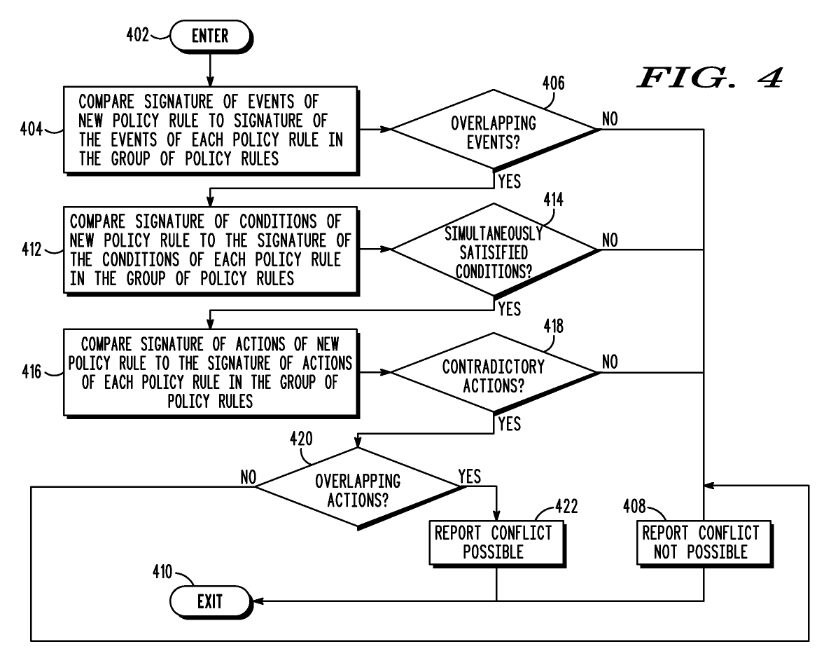

FIG. 4 is an operational flow diagram illustrating one process of identifying actual policy rule conflicts. The operational flow diagram of FIG. 4 begins at step 402 and flows directly into step 404. The conflict manager 118, at step 404, compares the signature of the Events of the new policy rule to the signature of the Events of each policy rule in the policy rule group. The conflict manager 118, at step 406, determines if the signature of the Events of the new policy rule and the signature of the Events of any one of the policy rules in the policy rule group overlap. If the result of this determination is negative, the conflict manager 118, at step 408, reports that a conflict is not possible. The control flow then exits at step 410.

If the result of the determination at step 406 is positive, then the conflict manager 118, at step 412, compares the signature of the Conditions of the new policy rule to the signature of the Conditions of each policy rule in the policy rule group. The conflict manager 118, at step 414, determines if the signature of the Conditions of the new policy rule and the signature of the Conditions of any one of the policy rules in the policy rule group can be simultaneously satisfied. If the result of this determination is negative, the conflict manager 118, at step 408, reports that a conflict is not possible. The control flow then exits at step 410. If the result of this determination is positive, the conflict manager 118, at step 416, compares the signature of the Actions of the new policy rule to the signature of the Actions of each policy rule in the policy rule group. The conflict manager 118, at step 418, determines if the signature of the Actions of the new policy rule and the signature of the Actions of any one of the policy rules in the policy rule group contradict each other (e.g. move the managed system into materially different states). If the result of this determination is negative, the conflict manager 118, at step 408, reports that a conflict is not possible. If the result of this determination is positive, the conflict manager 118, at step 420, determines if the signature of the actions of the new policy rule overlap with the signature of the Actions of any one of the policy rules in the policy rule group. If the result of this determination is negative, then the conflict manager 118, at step 408, reports that a conflict is not possible. If the result of this determination is positive, then the conflict manager 118, at step 422, reports that a conflict is possible.

Process of Identifying Actual Policy Rule Conflicts

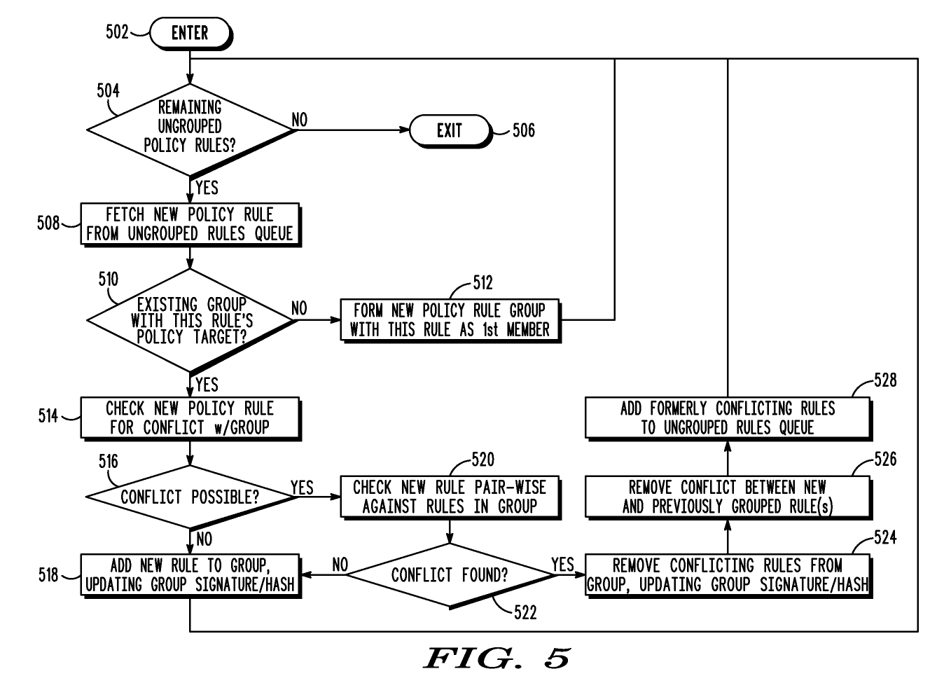

FIG. 5 is an operational flow diagram illustrating a more detailed process of FIG. 4. The operational flow diagram of FIG. 5 begins at step 502 and flows directly into step 504. The network manger 116, at step 504, determines if at least one ungrouped policy rule exists. For example, the network manager 116 determines if there are any policy rules that have not been added to a policy rule group. If the result of this determination is negative, the control flow exits at step 506. If the result of this determination is positive, the network manager 116, at step 508 retrieves a new policy rule from an ungrouped policy rules queue.

The network manager 116, at step 510, determines if a policy rule group exists that is associated with a characteristic such as a policy target that is common with the new policy rule retrieved from the ungrouped queue. If the result of this determination is negative, the network manager 116, at step 512, forms a new policy rule group with the retrieved rule as the first member. The control flow then returns to step 505.

If the result of the determination at step 510 is positive, the conflict manager 118, at step 514, checks for a conflict between the new policy rule and the policy rule group. The conflict manager 118, at step 516, determines if a conflict is possible. If the result of this determination is negative, the conflict manager 118, at step 518, adds the new policy rule to the policy group and updates the unique identifier (e.g. a signature or a hash) to reflect the added policy rule. The control flow then returns to step 504. If the result of the determination at step 516 is positive, the conflict manager 118, at step 520, checks the new policy rule pair-wise against each policy rule in the policy rule group.

The conflict manager 118, at step 522, determines if a conflict has been identified. If the result of this determination is negative, the control flows back to step 518. If result of this determination is positive, the conflict manager 118, at step 524, removes the conflicting rules from the policy rule group and updates the unique identifier to reflect the removed policy rule(s). The conflict manager 118, at step 526, notifies a user of the conflicting rules and/or resolves the conflict between the new policy rules and the previously group rule(s). The conflict manager 118, at step 528, then adds the formerly conflicting rules to the ungrouped rules queue. The control flow then returns to step 504.

Process of Managing a Policy Rule Group

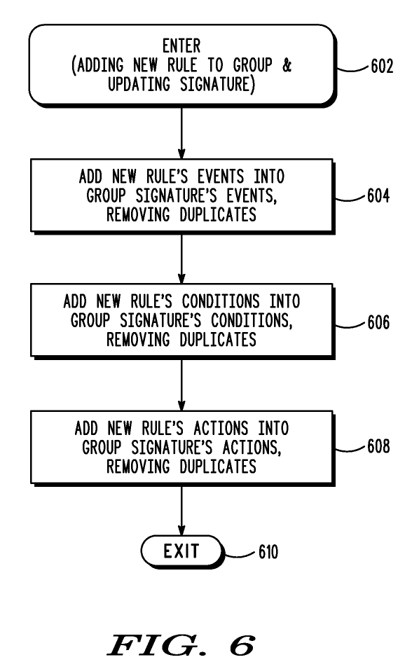

FIG. 6 is an operational flow diagram illustrating one process of managing a policy rule group. The operational flow diagram of FIG. 6 begins at step 602 and flows directly into step 604. The network manager 116 identifies a new policy rule having a common policy target or other characteristic as the policy rule group. The network manager 116, at step 604, adds the Events of the new policy rule into the policy rule group signature's events and removes any duplicates. The network manager 116, at step 606, adds the Conditions of the new policy rule into the policy rule group signature's Conditions and removes any duplicates. The network manager 116, at step 608, adds the Actions of duplicates. This aggregation of events, conditions, and actions of a group of policy rules forms a unique identifier such as a signature for quick assessment of the possibility of conflict between a new policy rule and policy rules in the policy group. The control flow then exits at step 610.

Computing System

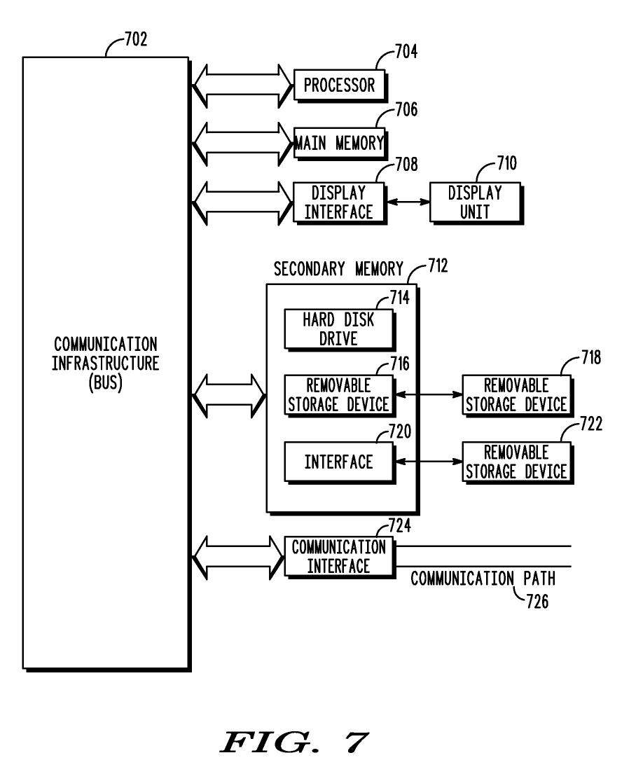

FIG. 7 is a high level block diagram illustrating a more detailed view of a computing system 700 such as the information processing system 102 useful for implementing the network manager 112 according to embodiments of the present invention. The computing system 700 is based upon a suitably configured processing system adapted to implement an exemplary embodiment of the present invention. For example, a personal computer, workstation, or the like, may be used.

In one embodiment of the present invention, the computing system 700 includes one or more processors, such as processor 704. The processor 704 is connected to a communication infrastructure 702 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 700 can include a display interface 708 that forwards graphics, text, and other data from the communication infrastructure 702 (or from a frame buffer) for display on the display unit 710. The computing system 700 also includes a main memory 706, preferably random access memory (RAM), and may also include a secondary memory 712 as well as various caches and auxiliary memory as are normally found in computer systems. The secondary memory 712 may include, for example, a hard disk drive 714 and/or a removable storage drive 716, representing a floppy disk drive, a magnetic tape drive, an optical disk drive, and the like. The removable storage drive 716 reads from and/or writes to a removable storage unit 718 in a manner well known to those having ordinary skill in the art.

Removable storage unit 718, represents a floppy disk, a compact disc, magnetic tape, optical disk, etc. which is read by and written to by removable storage drive 716. As are appreciated, the removable storage unit 718 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 712 may include other similar means for allowing computer programs or other instructions to be loaded into the computing system 700. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computing system 700.

The computing system 700, in this example, includes a communications interface 724 that acts as an input and output and allows software and data to be transferred between the computing system 700 and external devices or access points via a communications path 726. Examples of communications interface 724 may include a modem, a network interface (such as an Ethernet card), a communications port, a PCMCIA slot and card, etc. Software and data transferred via communications interface 727 are in the form of signals which may be, for example, electronic, electromagnetic, optical, or other signals capable of being received by communications interface 724. The signals are provided to communications interface 724 via a communications path (i.e., channel) 726. The channel 726 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product”, and “computer program storage product” are used to generally refer to media such as main memory 706 and secondary memory 712, removable storage drive 716, and a hard disk installed in hard disk drive 714. The computer program products are means for providing software to the computer system. The computer readable medium allows the computer system to read data, instructions, messages or message packets, and other computer readable information from the computer readable medium.

Computer programs (also called computer control logic) are stored in main memory 706 and/or secondary memory 712. Computer programs may also be received via communications interface 724. Such computer programs, when executed, enable the computer system to perform the features of the various embodiments of the present invention as discussed herein. In particular, the computer programs, when executed, enable the processor 704 to perform the features of the computer system.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method of managing policy rules, wherein the method comprises:
comparing a first unique identifier associated with a first policy rule to at least a second unique identifier associated with a second policy rule in a set of policy rules, wherein the first policy rule and each policy rule in the set of policy rules are associated with at least one common characteristic;
wherein in response to the first unique identifier failing to substantially match the at least second unique identifier,
updating the set of policy rules to include the policy rule; and
wherein in response to the first unique identifier substantially matching the at least second unique identifier,
generating a notification indicating a potential policy rule conflict exits between the policy rule and the set of policy rules.

2. The method of claim 1, wherein in response to the first unique identifier substantially matching the at least second unique identifier,
comparing the first unique identifier to at least a third unique identifier associated with at least one policy rule in the set of policy rules;
wherein in response to the first unique identifier failing to substantially match the at least third unique identifier,
updating the set of policy rules to include the policy rule;
wherein in response to the first unique identifier substantially matching the at least third unique identifier,
removing the at least one policy in the set of policies from the set of policies; and
performing at least one conflict resolution operation on the policy rule and the policy rule that has been removed from the set of policy rules.

3. The method of claim 1, wherein the at least one common characteristic is at least one of:
a common policy target;
a common policy rule event;
a common policy rule condition; and
a common policy rule action.

4. The method of claim 1, wherein updating the set of policy rules in response to the first unique identifier failing to substantially match the at least second unique identifier includes:
updating the second unique identifier to include information associated with the policy rule.

5. The method of claim 2, wherein updating the set of policy rules in response to the first unique identifier failing to substantially match the third unique identifier includes:
updating the second unique identifier to include information associated with the policy rule.

6. The method of claim 2, further comprising:
updating, in response to removing the at least one policy in the set of policies from the set of policies, the second unique identifier associated with the set of policy rules to reflect that the policy rule associated with the third unique identifier has been removed from the set of policy rules.

7. The method of claim 2, wherein the comparing the first signature to the at least a third signature comprises:
comparing the first signature to the third unique identifier using a pair-wise operation.

8. The method of claim 1, wherein comparing a first unique identifier associated with a first policy rule to at least a second unique identifier associated with a second policy rule in a set of policy rules, further comprises:
comparing at least one Event associated with the policy rule to at least one Event associated with the set of policy rules;
determining if the Event associated with the policy rule and the Event associated with the set of policy rules overlap,
wherein in response to the Event associated with the policy rule and the Event associated with the set of policy rules failing to overlap,
generating a notification that the policy rule and the policy rules in the set of policy rules are non-conflicting.

9. The method of claim 8, wherein in response to the Event associated with the policy rule and the Event associated with the set of policy rules overlapping,
comparing at least one Condition associated with the policy rule to at least one Condition associated with the set of policy rules;
determining if the Condition associated with the policy rule and the Condition associated with the set of policy rules are satisfied at a substantially identical time,
wherein in response to the Condition associated with the policy rule and the Condition associated with the set of policy rules failing to satisfied at a substantially identical time, and
generating a notification that the policy rule and the policy rules in the set of policy rules are non-conflicting.

10. The method of claim 9, wherein in response to the Condition associated with the policy rule and the Condition associated with the set of policy rules being satisfied at a substantially identical time,
comparing at least one Action associated with the policy rule to at least one Action associated with the set of policy rules;
determining if the Action associated with the policy rule and the Action associated with the set of policy rules are contradictory such that the Action associated with the policy rule and the Action associated with the set of policy rules place a managed entity in a different state,
wherein in response to the Action associated with the policy rule and the Action associated with the set of policy rules failing to be contradictory, and
generating a notification that the policy rule and the policy rules in the set of policy rules are non-conflicting.

11. The method of claim 10, wherein in response to the Action associated with the policy rule and the Action associated with the set of policy rules being contradictory,
determining if the Action associated with the policy rule and the Action associated with the set of policy rules are overlapping,
wherein in response to the Action associated with the policy rule and the Action associated with the set of policy rules fail to be overlapping, and
generating a notification that the policy rule and the policy rules in the set of policy rules are non-conflicting.

12. The method of claim 11, wherein in response to the Action associated with the policy rule and the Action associated with the set of policy rules overlapping,
generating the notification indicating a potential policy rule conflict exits between the policy rule and the set of policy rules.

13. An information processing system for managing policy rules, wherein the information processing system comprises:
a memory;
a processor communicatively coupled to the memory; and
a network manager communicatively coupled to the memory and the processor, wherein the network manager is adapted to:
compare a first unique identifier associated with a first policy rule to at least a second unique identifier associated with a second policy rule in a set of policy rules, wherein the first policy rule and each policy rule in the set of policy rules are associated with at least one common characteristic;
wherein in response to the first unique identifier failing to substantially match the at least second unique identifier,
update the set of policy rules to include the policy rule; and
wherein in response to the first unique identifier substantially matching the at least second unique identifier,
generate a notification indicating a potential policy rule conflict exits between the policy rule and the set of policy rules.

14. The information processing system of claim 13, wherein in response to the first unique identifier substantially matching the at least second unique identifier, the network manager is further adapted to:
compare the first unique identifier to at least a third unique identifier associated with at least one policy rule in the set of policy rules;
wherein in response to the first unique identifier failing to substantially match the at least third unique identifier,
update the set of policy rules to include the policy rule;
wherein in response to the first unique identifier substantially matching the at least third unique identifier,
remove the at least one policy in the set of policies from the set of policies; and
perform at least one conflict resolution operation on the policy rule and the policy rule that has been removed from the set of policy rules.

15. The information processing system of claim 13, wherein the network manager is further adapted to compare a first unique identifier associated with a first policy rule to at least a second unique identifier associated with a second policy rule in a set of policy rules by:
comparing at least one Event associated with the policy rule to at least one Event associated with the set of policy rules;
determining if the Event associated with the policy rule and the Event associated with the set of policy rules overlap,
wherein in response to the Event associated with the policy rule and the Event associated with the set of policy rules failing to overlap,
generating a notification that the policy rule and the policy rules in the set of policy rules are non-conflicting,
wherein in response to the Event associated with the policy rule and the Event associated with the set of policy rules overlapping,
compare at least one Condition associated with the policy rule to at least one Condition associated with the set of policy rules;
determine if the Condition associated with the policy rule and the Condition associated with the set of policy rules are satisfied at a substantially identical time, and
wherein in response to the Condition associated with the policy rule and the Condition associated with the set of policy rules failing to satisfied at a substantially identical time the network manager is adapted to,
generate a notification that the policy rule and the policy rules in the set of policy rules are non-conflicting.

16. The method of claim 15, wherein in response to the Condition associated with the policy rule and the Condition associated with the set of policy rules being satisfied at a substantially identical time,
comparing at least one Action associated with the policy rule to at least one Action associated with the set of policy rules;
determining if the Action associated with the policy rule and the Action associated with the set of policy rules are contradictory such that the Action associated with the policy rule and the Action associated with the set of policy rules place a managed entity in a different state,
wherein in response to the Action associated with the policy rule and the Action associated with the set of policy rules failing to be contradictory,
generating a notification that the policy rule and the policy rules in the set of policy rules are non-conflicting;
wherein in response to the Action associated with the policy rule and the Action associated with the set of policy rules being contradictory,
determining if the Action associated with the policy rule and the Action associated with the set of policy rules are overlapping,
wherein in response to the Action associated with the policy rule and the Action associated with the set of policy rules fail to be overlapping, and
generating a notification that the policy rule and the policy rules in the set of policy rules are non-conflicting,
wherein in response to the Action associated with the policy rule and the Action associated with the set of policy rules overlapping,
generating the notification indicating a potential policy rule conflict exits between the policy rule and the set of policy rules.

17. A system for managing policy rules, wherein the system comprises:
at least one network;
a plurality of managed entities communicatively coupled to the network; and
at least one information processing system communicatively coupled to the plurality of managed entities, wherein the information processing system includes:
a memory;
a processor communicatively coupled to the memory; and
a network manager communicatively coupled to the memory and the processor, wherein the network manager is adapted to:
compare a first unique identifier associated with a first policy rule to at least a second unique identifier associated with a second policy rule in a set of policy rules, wherein the first policy rule and each policy rule in the set of policy rules are associated with at least one common characteristic;
wherein in response to the first unique identifier failing to substantially match the at least second unique identifier,
update the set of policy rules to include the policy rule; and
wherein in response to the first unique identifier substantially matching the at least second unique identifier,
generate a notification indicating a potential policy rule conflict exits between the policy rule and the set of policy rules.

18. The system of claim 17, wherein in response to the first unique identifier substantially matching the at least second unique identifier, the network manager is further adapted to:
compare the first unique identifier to at least a third unique identifier associated with at least one policy rule in the set of policy rules;
wherein in response to the first unique identifier failing to substantially match the at least third unique identifier,
update the set of policy rules to include the policy rule;
wherein in response to the first unique identifier substantially matching the at least third unique identifier,
remove the at least one policy in the set of policies from the set of policies; and
perform at least one conflict resolution operation on the policy rule and the policy rule that has been removed from the set of policy rules.

19. The system of claim 17, wherein the network manager is further adapted to compare a first unique identifier associated with a first policy rule to at least a second unique identifier associated with a second policy rule in a set of policy rules by:
comparing at least one Event associated with the policy rule to at least one Event associated with the set of policy rules;
determining if the Event associated with the policy rule and the Event associated with the set of policy rules overlap,
wherein in response to the Event associated with the policy rule and the Event associated with the set of policy rules failing to overlap,
generating a notification that the policy rule and the policy rules in the set of policy rules are non-conflicting,
wherein in response to the Event associated with the policy rule and the Event associated with the set of policy rules overlapping,
compare at least one Condition associated with the policy rule to at least one Condition associated with the set of policy rules;
determine if the Condition associated with the policy rule and the Condition associated with the set of policy rules are satisfied at a substantially identical time, and
wherein in response to the Condition associated with the policy rule and the Condition associated with the set of policy rules failing to satisfied at a substantially identical time the network manager is adapted to,
generate a notification that the policy rule and the policy rules in the set of policy rules are non-conflicting.

20. The system of claim 19, wherein in response to the Condition associated with the policy rule and the Condition associated with the set of policy rules being satisfied at a substantially identical time,
comparing at least one Action associated with the policy rule to at least one Action associated with the set of policy rules;
determining if the Action associated with the policy rule and the Action associated with the set of policy rules are contradictory such that the Action associated with the policy rule and the Action associated with the set of policy rules place a managed entity in a different state,
wherein in response to the Action associated with the policy rule and the Action associated with the set of policy rules failing to be contradictory,
generating a notification that the policy rule and the policy rules in the set of policy rules are non-conflicting;
wherein in response to the Action associated with the policy rule and the Action associated with the set of policy rules being contradictory,
determining if the Action associated with the policy rule and the Action associated with the set of policy rules are overlapping,
wherein in response to the Action associated with the policy rule and the Action associated with the set of policy rules fail to be overlapping, and
generating a notification that the policy rule and the policy rules in the set of policy rules are non-conflicting,
wherein in response to the Action associated with the policy rule and the Action associated with the set of policy rules overlapping,
generating the notification indicating a potential policy rule conflict exits between the policy rule and the set of policy rules.
